(19) United States
(12) Patent Application Publication
(10) Pub. No.: US 2014/0250829 A1
(43) Pub. Date: Sep. 11, 2014

(54) AUTOMATED DISPENSING SYSTEM

(71) Applicant: Robert Terzini, Corinth, TX (US)

(72) Inventor: Robert Terzini, Corinth, TX (US)

(73) Assignee: Tension Envelope Corporation, Kansas City, MO (US)

(21) Appl. No.: 14/201,768

(22) Filed: Mar. 7, 2014

Related U.S. Application Data
(60) Provisional application No. 61/774,332, filed on Mar. 7, 2013.

(51) Int. Cl. B65B 1/00; B65C 9/26

(52) U.S. Cl. CPC B65B 1/00; B65C 9/26
USPC 53/131.2

(57) ABSTRACT

An automated dispensing system includes a container dispensing module for storing and discharging a plurality of small object containers, a printer applicator for printing selected information on a label and positioned to apply the label to a container as it is discharged from the dispensing module, a plurality of product dispensing modules for storing and dispensing a selected number of small objects into a labeled container, a container transport unit, a conveyor assembly for transporting filled containers away, and a control unit for coordinating and controlling operation for the dispensing system. A container transport unit picks a labeled container from the container dispensing module, transports it along a track to a selected product dispensing cell, and travels back along the track to the container dispensing module while the product dispensing module fills and ejects the filled container onto an adjacent conveyor.

### FIELD

The present disclosure generally relates to a product dispensing system. More particularly, it concerns an automated system for dispensing small objects into labeled containers.

### BACKGROUND

Automated small object dispensing systems distribute products from a stored inventory into containers based on customer orders. They are able to dispense a greater number of different products in a shorter time and with fewer errors than manual distribution. Such systems may include an array of dispensing cells loaded with small objects, one or more hoppers loaded with containers, one or more traveling robotic dispensing units, a label station and a control system that receives dispensing instructions and actuates each of these elements in a coordinated manner. Typically, an order is entered into the control system and a control unit directs a robotic unit to travel to the location of a hopper where the robot deploys structure such as a manipulator arm to grasp a container. The control unit then directs the robot to transport the container to the location of a dispensing cell containing the ordered product. The robot may be equipped with an optical scanner that reads an identifying code on the dispensing cell and transmits it to the control system. The control system compares the dispensing cell code with information stored in a database to confirm that the correct small object products are present in the dispensing cell. If there is a match, the robot is directed to present the container to the dispensing cell, which is directed to count out the ordered quantity of its stored small objects into the container. Once the container has been filled, the robot is directed to transport the container to a printer/labeling station. This may be accomplished by depositing the container on a conveyor, which transports the containers in the order filled to the labeling station, where labels are printed and applied. Because the filled containers lack any identifying indicia for the products contained therein, it is important that they are labeled in the order in which they were filled.

Because of its high speed and moving parts, automated dispensing machinery is generally housed in an enclosure or cabinet. When the dispensing cells require replenishment with small object products, a technician opens a cabinet door, removes the low cell and refills it. During the replenishment process, the dispensing robots cease travel, and production stops, reducing overall throughput.

The throughput speed of such automated dispensing systems is limited by the need for the robot to wait at the dispensing cell while the objects are deposited into the container, the need to keep the filled containers in order until they have been labeled, and by stoppage of the system when the dispensing cells require refilling. The throughput of these systems is generally less than 150 filled containers per hour. This is far short of the needs of certain industries, such as central-fill pharmacies, which must fill as many as 1000 containers per hour. Various attempts have been made to increase throughput, for example, by modifying certain dispensing cells to include counter units and holding tanks for receiving separately counted objects. These cells are signaled by the control system to count small objects into a holding tank or receptacle in the dispensing cell. When the robot presents an empty container at the dispensing cell, a gate is actuated to empty the contents of the receptacle into the container. This enables multiple dispensing cells to count objects separately into their respective receptacles while the robot obtains an empty container. The ability to concurrently count more than one order and to transfer pre-counted objects from a receptacle at the dispenser cell to the container in a single action cooperate to speed up throughput of the system. However, production remains limited by the travel time required for the robots to transport a container from the location of a hopper to the dispensing cell, position the container under the receptacle, transfer contents from the receptacle to the container, and transport each filled container to the discharge conveyor.

Accordingly, there is a need for an improved high output dispensing unit that can fill and dispense hundreds of labeled containers per hour and verify the contents of the filled containers with the label information, without the need for stoppage of the system to refill the dispensing cells.

### SUMMARY

An automated small object dispensing system includes a container dispensing module for storing and discharging a plurality of small object containers, a printer applicator for printing selected information on a label and applying the label to a container as it is discharged, a plurality of product dispensing modules for storing and dispensing a selected number of small objects into a labeled container, a container transport unit for picking a container from the container dispensing module after it is labeled and transporting it to a selected product dispensing cell to be filled, a conveyor assembly for transporting the filled containers away, and a control unit for coordinating and controlling operation for the dispensing system.

The container dispensing module includes a container bulk storage hopper with a discharge chute having a gating mechanism disposed to meter discharge of one container at a time from the discharge chute. The printer applicator is disposed below the discharge chute and includes a platform for receiving a container as it is released from the chute. The platform includes a shiftable gate covering an opening to a container well that is disposed below. The container is deposited onto the slidable gate, where it is labeled. The gate is then actuated to slide away from the well opening, allowing the labeled container to drop into the well. The container transport unit includes a manipulator arm disposed on a slidable rail to travel to the container well, grasp a labeled container, remove it from the well for delivery to a filling port at a product dispensing module while a next container is labeled on the gate above, and deliver it to a filling port at a product dispensing module.

At the filling port, the container is filled by a dispensing cell of the product dispensing module with a quantity of a preselected product. The filling port includes a base, a rear wall, a pair of sidewalls and a front opening. A lift unit interconnects the base and the dispensing cell and is actuable to raise and lower the filling port with respect to the dispensing cell. The filling port also includes structure actuable to shift the rear wall of the port forwardly past the opening, thereby ejecting the filled container from the filling port when the port is in a lowered position, and onto an adjacent conveyor. The conveyor assembly includes a multi-tiered conveyor system. Elevator and lowerator units are disposed adjacent the conveyor tiers to move labeled, filled containers to a discharge conveyor tier.

In a method of dispensing small objects, a labeled container is picked from the container well and transported to a product dispensing module while the next container dispensed from the hopper is labeled. Another transport arm returns for the next labeled container. A plurality of containers may be filled concurrently by respective multiple dispensing units. After filling, each filled container is deposited onto a conveyor. Elevator and lowerator units transfer the filled containers from the various conveyor tiers onto a discharge conveyor, which transports the filled containers to verification and capping stations.

Various objects, features aspects and advantages of this disclosure will become apparent to those skilled in the art from the following detailed description, which, taken in conjunction with the accompanying drawings, discloses exemplary embodiments of the present dispensing system and method.

### BRIEF DESCRIPTION OF THE DRAWINGS

FIG. 1 is a perspective view of an automatic dispensing system in accordance with the disclosure;

FIG. 1A is a block diagram of a control system of the automatic dispensing system;

FIG. 2 is a view similar to FIG. 1 with the frame removed;

FIG. 3 is a view similar to FIG. 2 with the robot housings and X-Y arms removed;

FIG. 4 is a view similar to FIG. 3 with the gripper arms and conveyor belts removed;

FIG. 5 is a rear perspective view of the robotic pick and place assembly shown in FIG. 1 with parts removed to show movement of the vertical sliding rails and range of motion of the manipulator arms;

FIG. 6 is an enlarged view of the bulk hopper and printer applicator assembly;

FIG. 7 is a greatly enlarged view of the printer applicator assembly showing a labeled container in lowered position for pick up;

FIG. 8 is an enlarged view of a product dispensing module, conveyor and robot gripper arm portion, showing the gripper in a retracted position and closed about a container;

FIG. 9 is similar to FIG. 8, showing the gripper arm with container extended to deliver the container to the dispenser port;

FIG. 10 is similar to FIG. 9, with the gripper arm open and retracting following delivery of the container to the port;

FIG. 11 is similar to FIG. 10, with the port in a lowered position in a plane with the conveyor and the push assembly retracted;

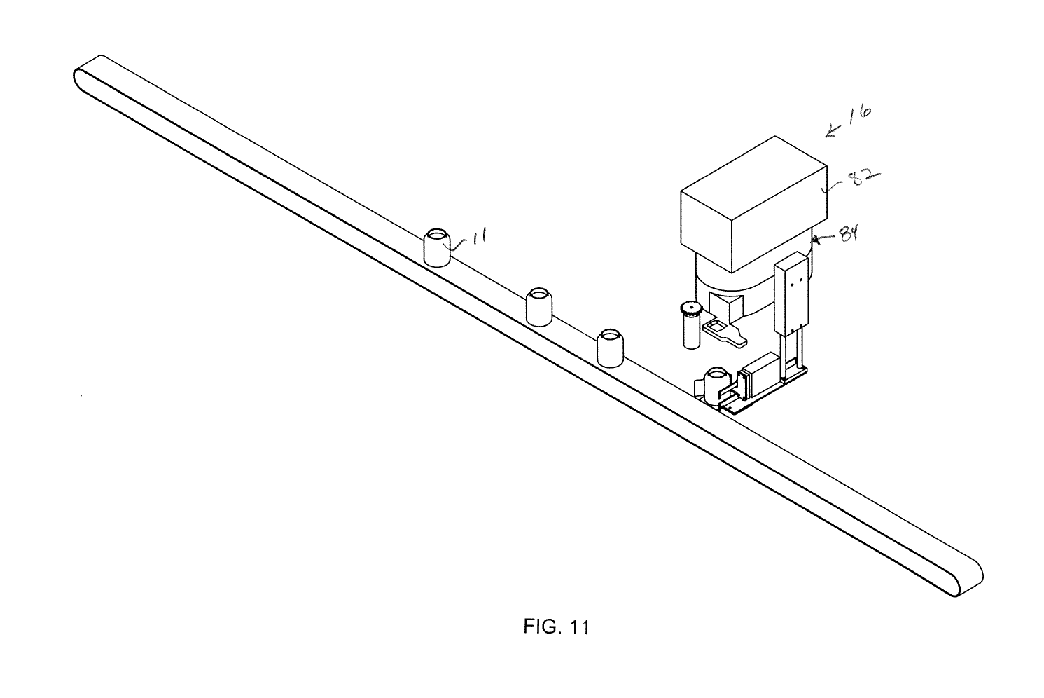

FIG. 12 is similar to FIG. 10, with the push assembly extended and a pushed container positioned on the conveyor;

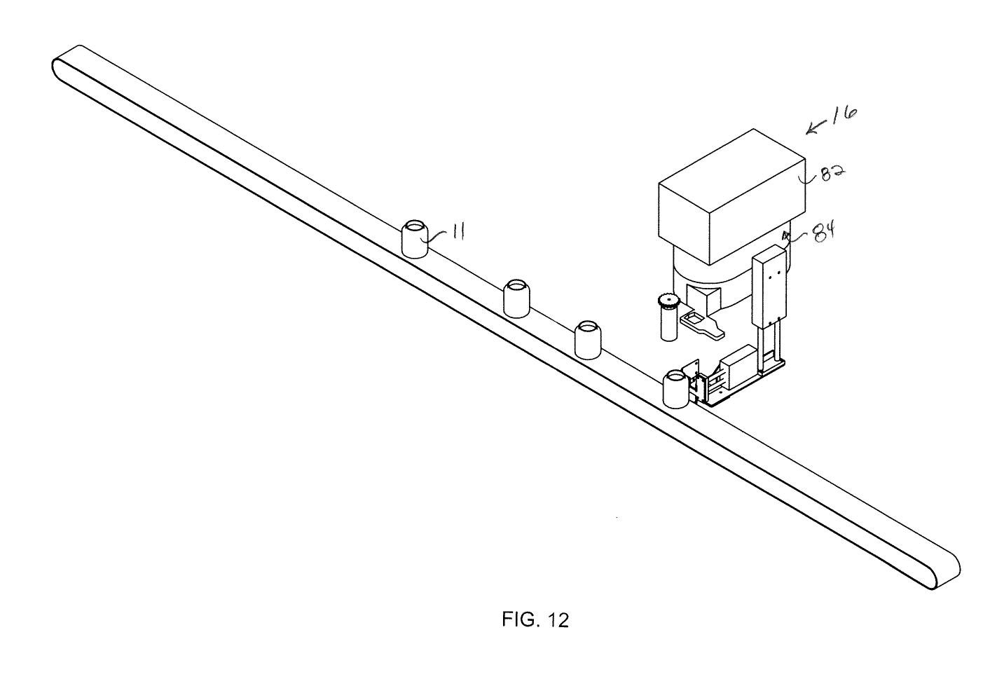

FIG. 13 is an enlarged view of the conveyor assembly, showing exemplary elevator and lowerator assemblies;

FIG. 14 is a similar to FIG. 13, showing the elevator and lowerator assemblies;

FIG. 15 is a greatly enlarged view of a product dispensing module shown in FIG. 12;

FIG. 16 is similar to FIG. 15 with the container removed to show details of the push mechanism;

FIG. 17 is a greatly enlarged view of the dispensing module shown in FIG. 11, with the container removed to show details of the container port with the push mechanism in a retracted position;

FIG. 18 is a flow diagram showing operation of the automatic dispensing system; and

FIG. 19 is a flow diagram showing the process of marrying a dispensing cell and a storage canister to a dispensing unit location and replenishing a dispensing unit.

### DETAILED DESCRIPTION

Selected embodiments of the present invention will now be explained with reference to the drawings. It will be apparent to those skilled in the art from this disclosure that the following descriptions of the embodiments are provided for illustration only and not for the purpose of limiting the invention as defined by the appended claims and their equivalents.

Referring now to the drawing figures, the reference numeral 10 refers to a small object dispensing system and method. The system 10 efficiently handles small objects from storage to dispensing into custom labeled containers 11 to provide enhanced throughput of dispensed products. The system 10 can accurately select and dispense the correct products into custom labeled containers and concurrently discharge multiple filled containers to a capping unit.

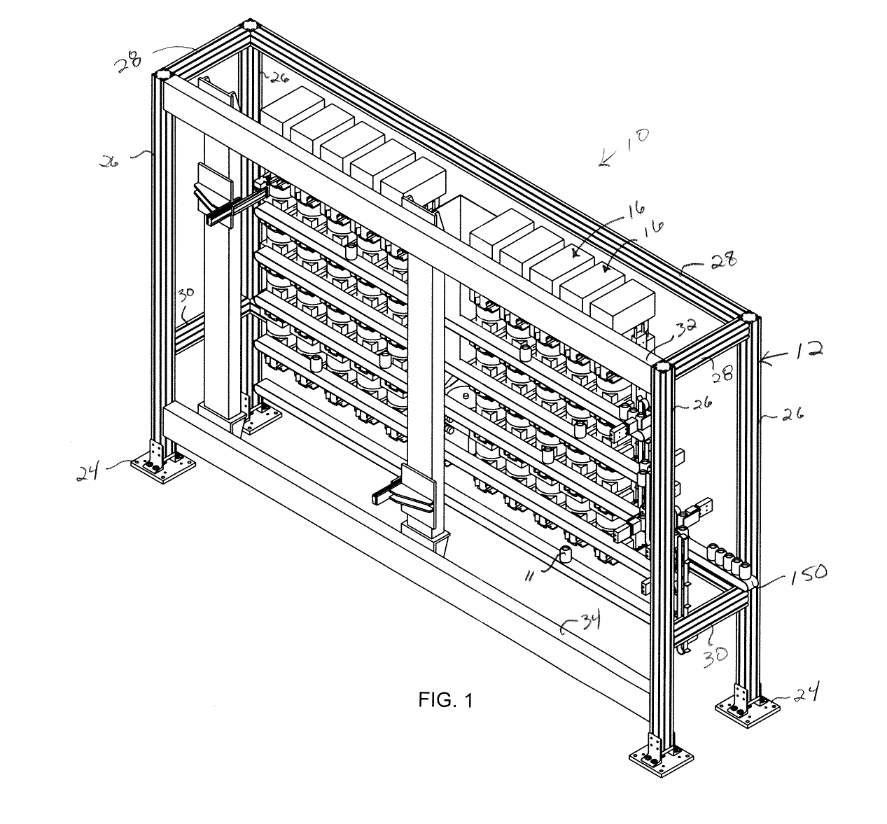

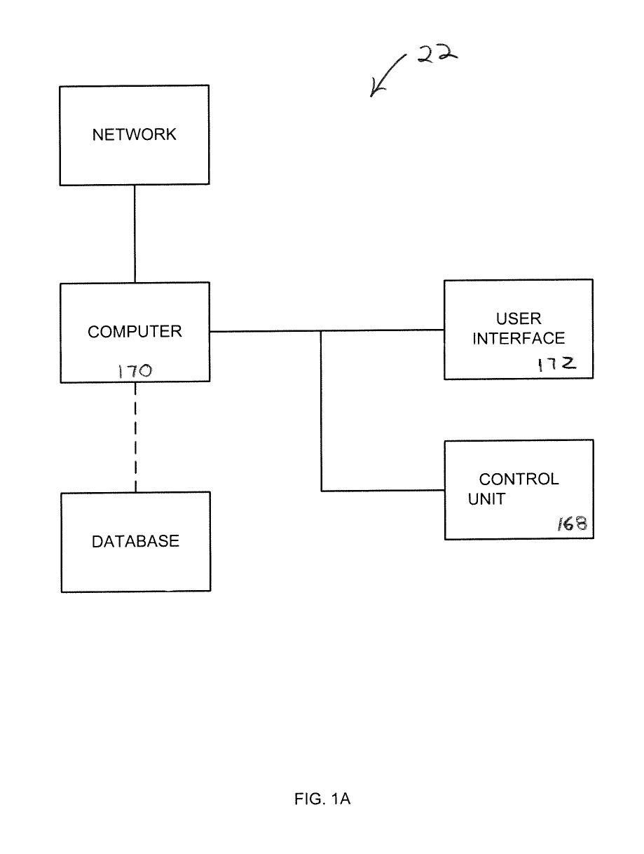

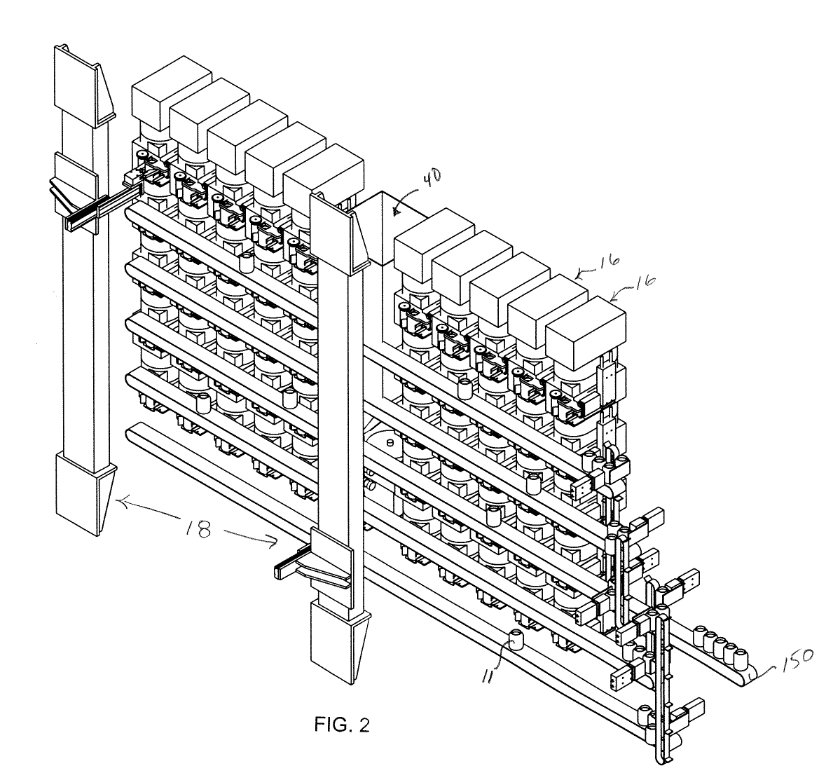

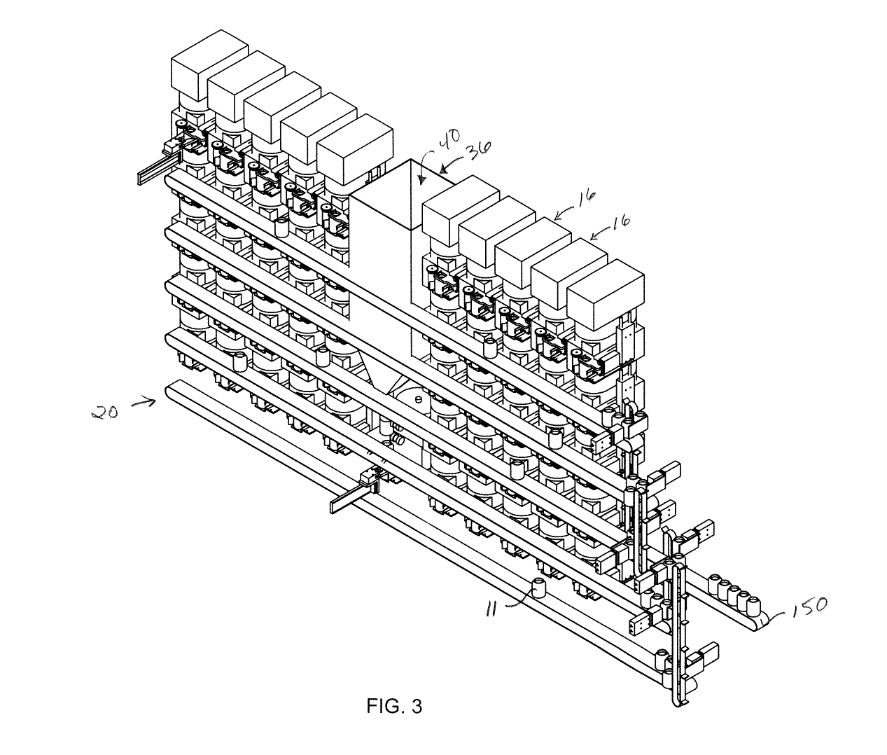

As best shown in FIGS. 1-4, the small object dispensing system 10 includes a framework 12 supporting a container dispenser and printer assembly 14, a plurality of product dispensing modules 16, a pair of container pick and place assemblies 18, multi-tier conveyor assembly 20, and control system 22. The container dispenser and printer assembly or container dispensing module 14 is disposed within the framework 12, with an array of product dispensing modules 16 on either side, thereby minimizing the travel required by the pick and place assemblies 18. The conveyor tiers 20 are arranged in front of the dispensing modules 16 and extend beyond the modules at one side to allow room for elevator and lowerator assemblies (to be described) which pass the filled containers to a discharge tier that conveys them away from the dispensing system 10 and to the next station in a production line.

Referring to FIGS. 1, 4 and 5, the support framework or rack 12 is shown to have a generally rectangular overall configuration. The framework 12 includes a plurality of leveling plates or feet 24 supporting a corresponding number of upright support posts 26 reinforced at the side and back by upper and lower beams 28 and 30. While posts are shown in the drawing figures, any suitable number may be employed, depending on the size of the framework. The beams 28 and 30 are positioned respectively adjacent the upper ends of the posts and at a spaced distance above the lower ends. At the front of the framework 12, the posts 26 are interconnected by upper and lower robot tracks 32 and 34, which provide for lateral travel of at least one pick and place robotic system to be described. The framework 12 may be enclosed for example, by sidewalls and doors to form a cabinet or the like, to keep dust and dirt from the equipment and dispensed objects, and to protect workers against contact with moving parts.

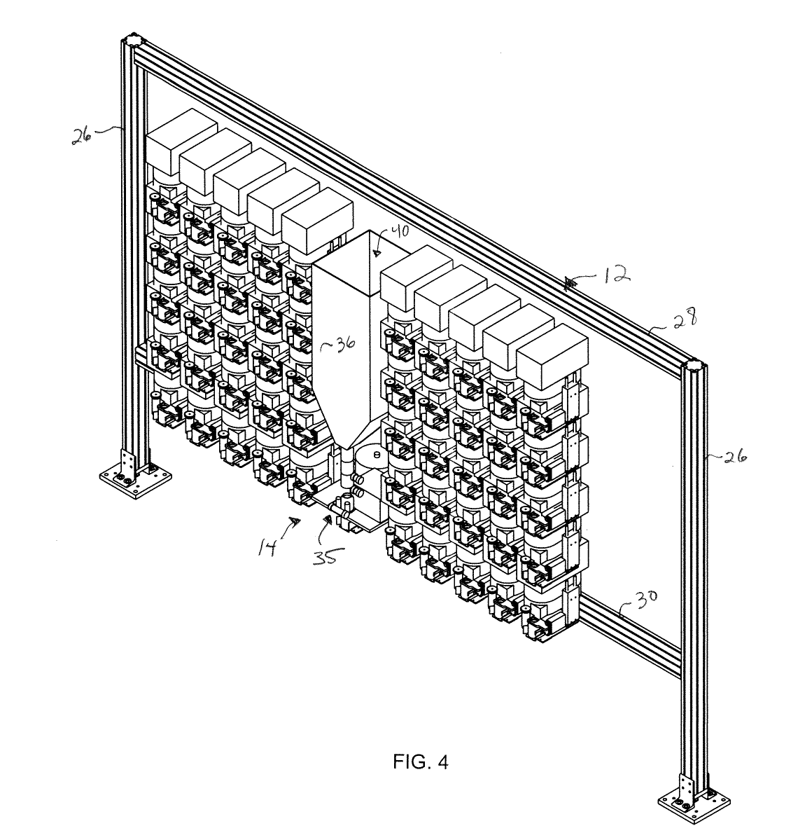

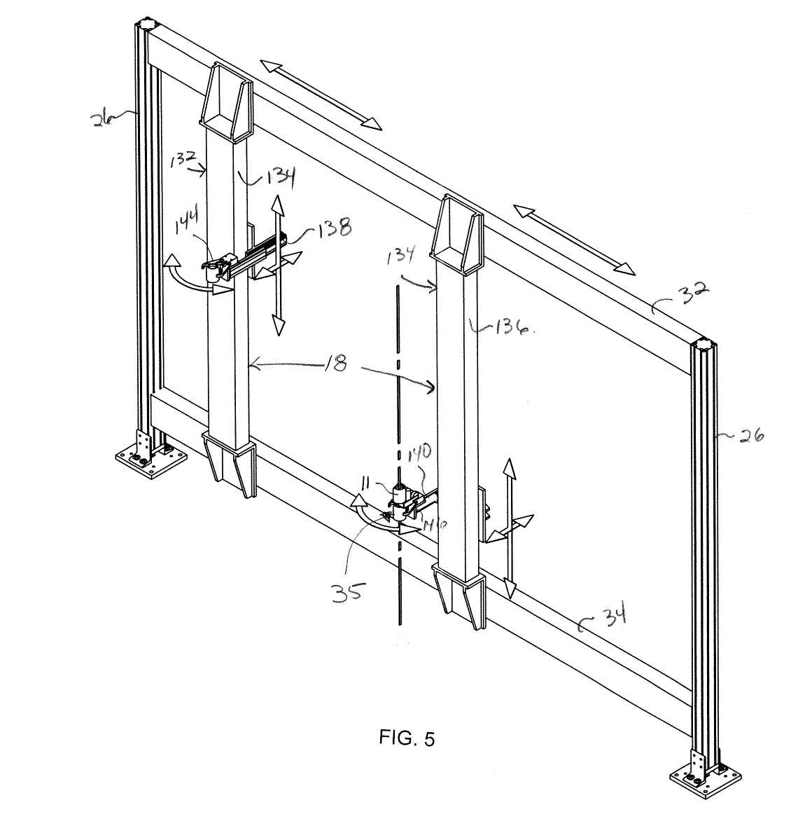

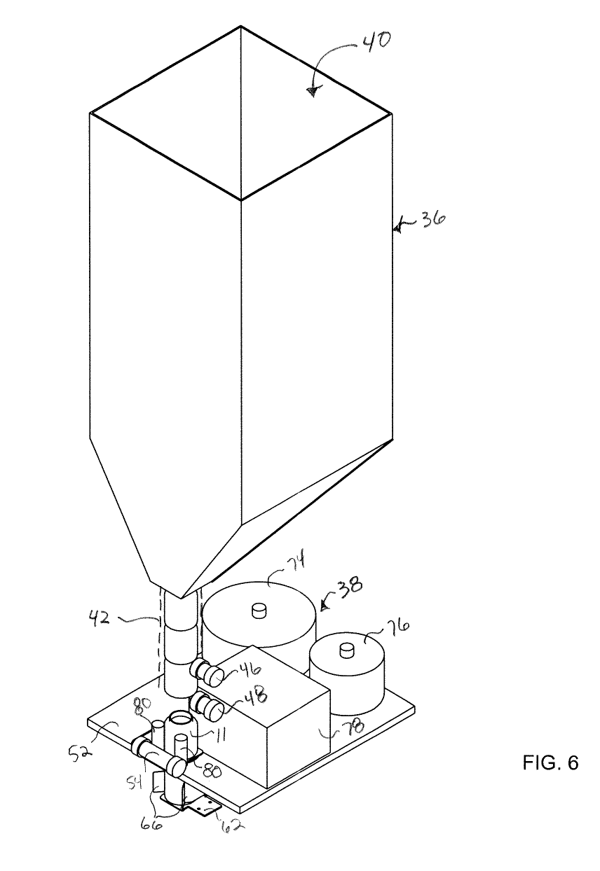

As shown in FIGS. 4 and 5, the container dispense and print assembly 14 is disposed within the framework 12 to define a labeled container pick location 35. While the dispense and print assembly 14 is depicted in the drawing figures with an array of approximately equal numbers of dispensing modules 16 positioned on either side, it is foreseen that more than one dispense and print assembly 14 may be provided, and that each assembly 14 need not be centrally positioned between the dispensing modules 16 on either side. The dispense-and-print assembly 14 includes a bulk container storage hopper 36 mounted above a print applicator subassembly or label unit 38 (FIG. 6). The hopper 36 includes an access port 40, which may be located at the back or top thereof to enable an operator to load it from behind, and a discharge chute 42 that depends below the hopper 36. The hopper 36 includes internal structure (not shown) for orienting the containers to an upright position as they enter the discharge chute 42 (FIG. 6), where they drop into a vertical line of containers in top-to-bottom relation.

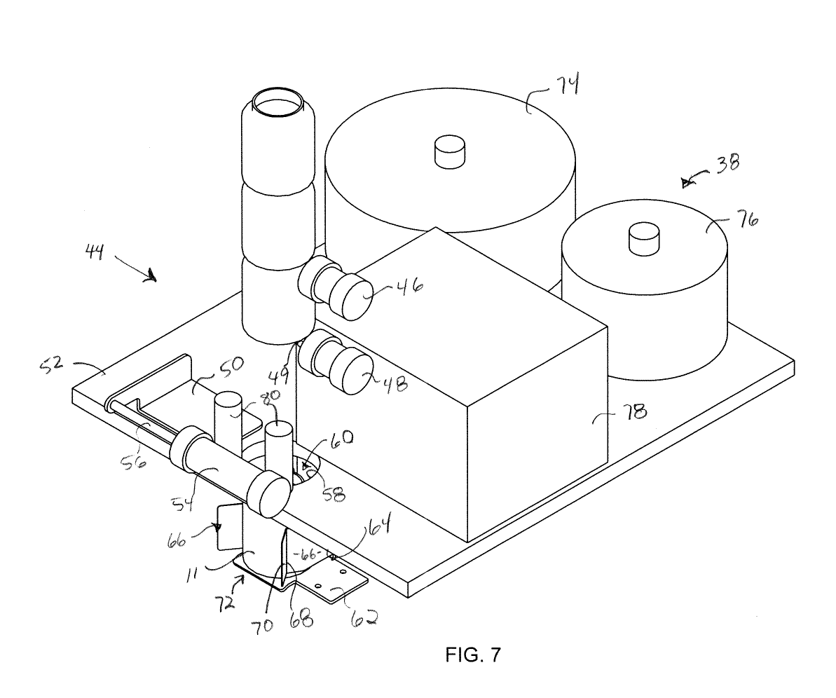

Discharge of the containers 11 is metered by a container gating assembly 44 (FIG. 7) that includes a pair of generally cylindrical upper and lower gates 46 and 48 positioned above a slidable gate 50. The gating cylinders are positioned adjacent the discharge chute 42 and the slidable gate 50 is connected to a base 52 supporting the printer applicator subassembly 38 below the hopper 36. The gating cylinder actuators are operable to extend and retract attached piston rods 49. This causes the cylinders 46 and 48 to shift from an extended or closed gate position, in which a line of containers 11 is retained within the chute 42, to a retracted or open gate position, which allows containers to be released from the chute 42 and drop downwardly toward the base 52. The piston rods 49 are extended and retracted in a cooperative manner to singulate container drop, so that only one container at a time is allowed to drop downwardly. The slidable gate 50 is operably connected to an actuator 54, which drives a piston rod 56 that moves the gate from a closed position (FIG. 6) to an open position (FIG. 7). When the gate 50 is in the closed position, it aligns with the discharge chute 42 to receive and support a dropped container 11 for labeling. When the gate 50 is in the open position, it exposes an aperture 58 in the base 52. The aperture 58 is sized to receive a recently labeled container 11, which drops through the aperture and into a container well 60.

The container well 60 is positioned below the base 52 in alignment with the discharge chute 42. The aperture 58 defines an upper opening to the container well 60, which includes a lower container support member or bottom plate 62, a back wall 64, and a pair of opposed sidewalls 66. The sidewalls 66 are formed as spring plates, each including a nip portion 68 and a flare portion 70. The flare portions 70 cooperatively define an opening 72 to the container well 60. The opening 72 is oriented toward the front of the framework 12, to provide for access by the mechanical arms of the pick and place assembly 18. The nip portions 68 cooperate to hold a container in place while it is in the well 60. The opening 72 is sized to enable a mechanical arm to reach into the well 60 to grasp a container 11. The spring construction of the flare portions 70 enables them to cooperate to flex sufficiently to enable the container to move past the nip portions 68 when it is grasped, allowing it to pass through the opening 72 for transport to a product dispensing module 16 for filling.

The printer applicator subassembly 38 includes a label reel 74, a substrate uptake or rewind reel 76, a printer applicator unit 78, and a pair of spin rollers 80, which are actuated by a motor (not shown) to rotate the containers and drive the print head of the applicator unit 78. While this configuration of print applicator components is well-suited to lined labels, it is foreseen that other suitable print configurations may be employed, for example, the substrate uptake reel may be omitted where linerless labels are employed. Other modifications may be made where more than one label is to be applied to a container. It is also foreseen that the labels may be omitted entirely and the printing applied directly to a surface of the product container.

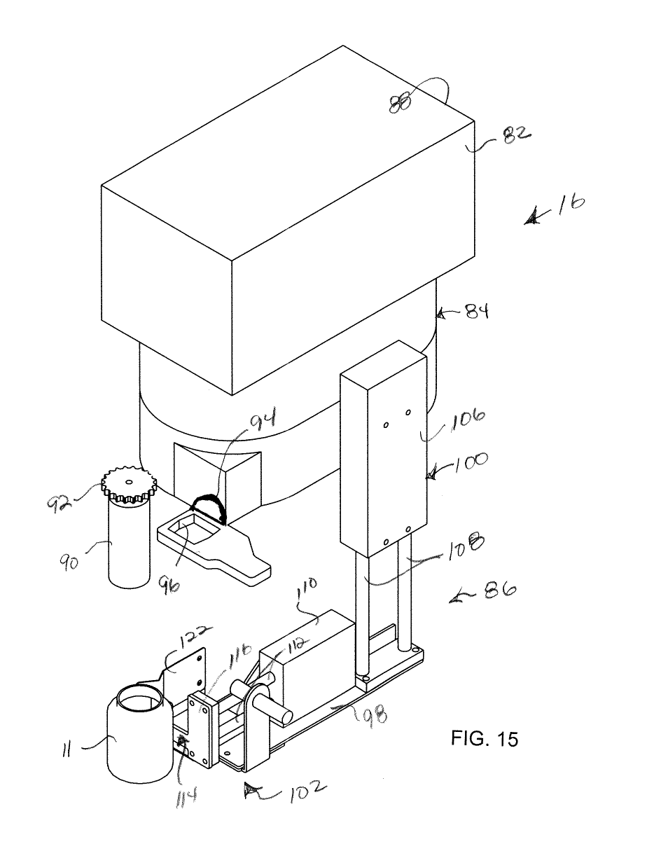

Referring now to FIGS. 1 and 15-17, the product dispensing modules 16 are disposed in vertical columns, rows or stacks on the framework 12, and in close spaced relation behind the conveyor tier assembly 20. Each product dispensing module includes a storage canister 82 positioned atop a product dispensing cell 84, which may comprise a so-called expanded product dispensing cell. A container induction module 86 is connected at one side of a housing of the dispensing cell 84.

The canister 82 is removably connected to the dispensing cell 84 so that it can be removed in its entirety for cleaning. The canister includes an access port 88 on the back side to enable safe access by a worker for replenishment with small object products without interrupting operation of the pick and place assembly 18, conveyors 20 or any other components of the dispensing system 10. An interior gating mechanism is actuable to release products downwardly from the canister 82 and into the interior of the dispensing cell 84.

One exemplary dispensing cell, which is well-adapted for dispensing medicaments, is described in U.S. Pat. No. 5,897,024, which is incorporated herein by reference to the extent not inconsistent with this disclosure. The dispensing cell described in the '024 patent includes a rotatable platen for sweeping medicaments toward dispensing structure that singulates the medicaments for discharge one unit at a time. The present dispensing cell 84 includes a drive motor 90 connected to a drive gear 92 that rotates a driven gear positioned inside the cell 84 and connected to a platen structure. Small objects are dispensed from the cell one at a time through an outlet 94 for counting by a sensor 96. In one embodiment a fiber optic counting sensor 96 is employed, although in another aspect, any suitable sensor may be used.

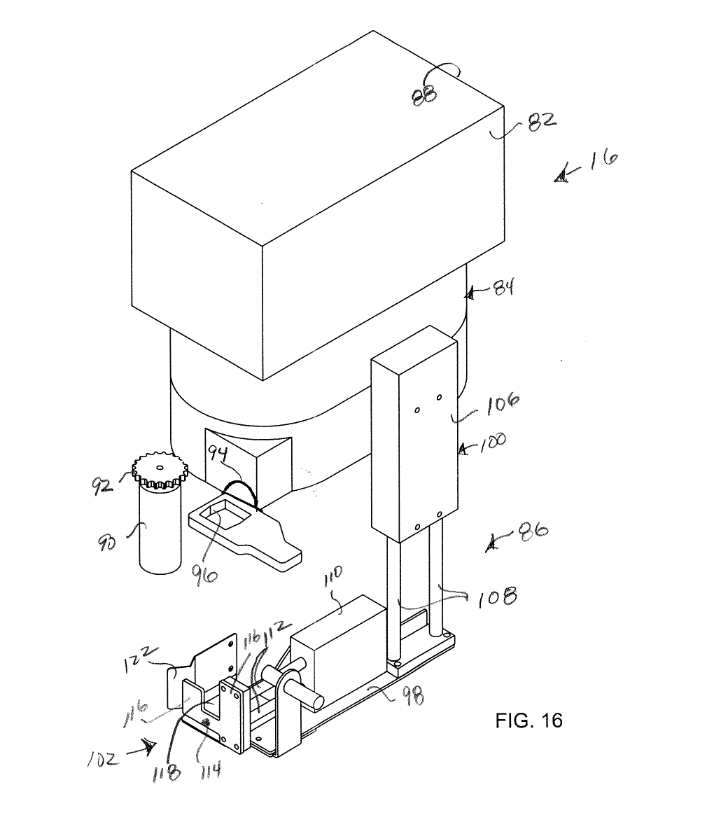

The container induction module 86 lowers a filled container 11 and shifts it onto the conveyor assembly 20 to be transported away for further processing. In combination with the container dispense and print assembly and the conveyor tier assembly, the container induction module eliminates the need for a pick and place unit to remain at the dispensing unit 16 while the container 11 is filled or, alternatively, to depart and then return to carry away the filled container. The container induction module 86 includes a base 98 connected at one end to a lift unit 100 and supporting a container ejection assembly 102 and a container filling port 104 positioned at the opposite end of the base. The lift unit 100 includes an actuator 106 operable to extend and retract a guided piston rod 108 connected at the base 98. The container ejection assembly 102 is connected to the base adjacent the guided rod of the lift unit 100 and includes an actuator 110 operable to extend and retract a guided piston rod 112 connected to an ejector or push plate 114. As best shown in FIG. 16, the push plate 114 has a pair of interconnected vertically oriented container guide arms 116 with a window area 118 therebetween.

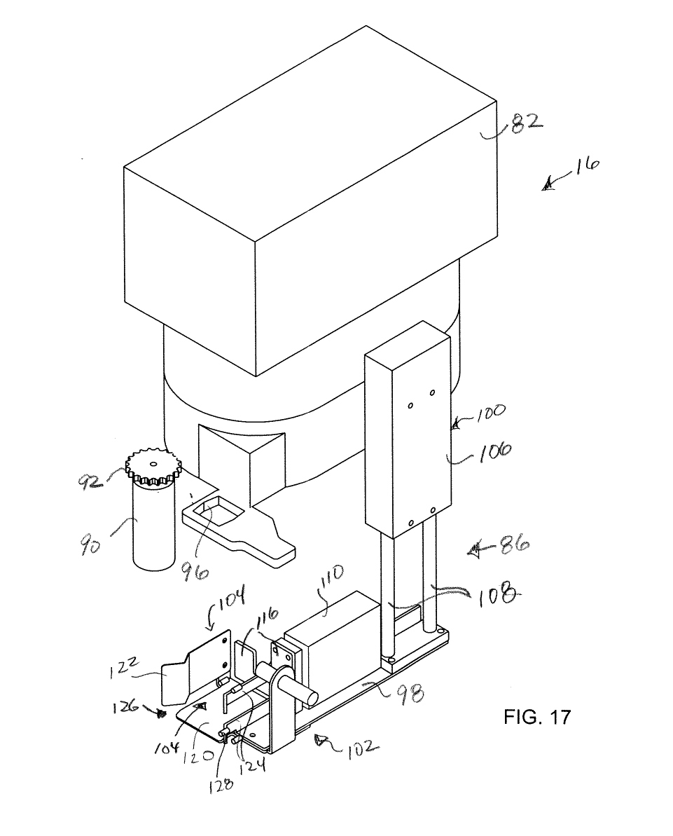

The container induction port 104 includes a base or bottom plate 120 connected to the base 98, a flexible sidewall 122 connected to the bottom plate 120, a fixed sidewall or side supports 124 connected at their inboard ends to the ejection actuator 110, and a rear or back wall formed by the ejector plate 114. The sidewalls 122 and 124 cooperatively form a front opening 126, which provides an opening through which the container 11 may be ejected. As best shown in FIG. 17, the flexible sidewall 122 is connected to the bottom plate 120, which is removably connected to the base 98 of the module 86 by one or more fasteners 128, such as a pin. The pin 128 may be released for removal and replacement of the bottom plate and sidewall 122 to enlarge the size of the port 104, enabling it to accommodate containers of different sizes and shapes. The flexible sidewall 122 is preferably constructed as a generally flat spring attached at the inboard end so that it will retain a container, but unattached at the outboard end to allow advancement of the container within the port for removal. The spring sidewall is crimped at a spaced distance from the outboard end to assist in retaining the container 11.

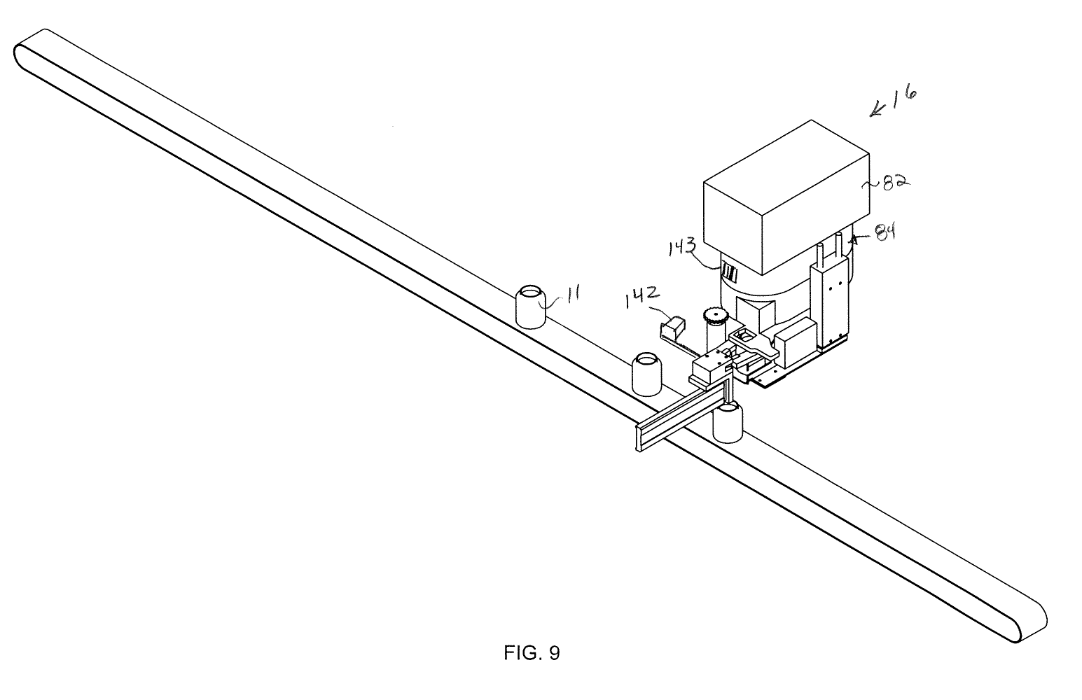

The pick and place assembly 18 is shown in FIGS. 1, 2 and 5 to include first and second robotic transfer units 132 and 134. The transfer units include respective first and second sliding rails 134 and 136 that are connected at the ends for sliding travel back and forth along the upper and lower tracks 32 and 34 of the support framework 12. (FIG. 5) First and second pick and place or manipulator arms 138 and 140 are mounted for sliding travel up and down along the respective rails 134 and 136. The manipulator arms are each equipped with an optical scanner unit 142 (FIG. 9) for reading identifying codes such as a bar code 143 on the dispensing cells 84 and transmitting them to the control system 22. A respective first or second container grip unit 144 or 146 is connected at the end of each arm, and is configured as a pair of jaws, operable to open and close around a container. Exemplary robotic transfer units are disclosed in U.S. Pat. No. 6,658,324 and US Patent Publication No. 2012/029,0128, which are incorporated by reference to the extent they do not conflict with the present disclosure. As shown in FIG. 5, the travel of the rails 134 and 136 along the tracks 32 and 34 enables the arms 138 and 140 to travel back and forth along a lateral axis. In addition, the arms are mounted for sliding movement up and down along a vertical axis defined by each of the rails 134 and 136. The arms also include structure enabling sliding movement inboard and outboard along a horizontal axis as well as movement in a horizontal arc as shown in FIG. 5.

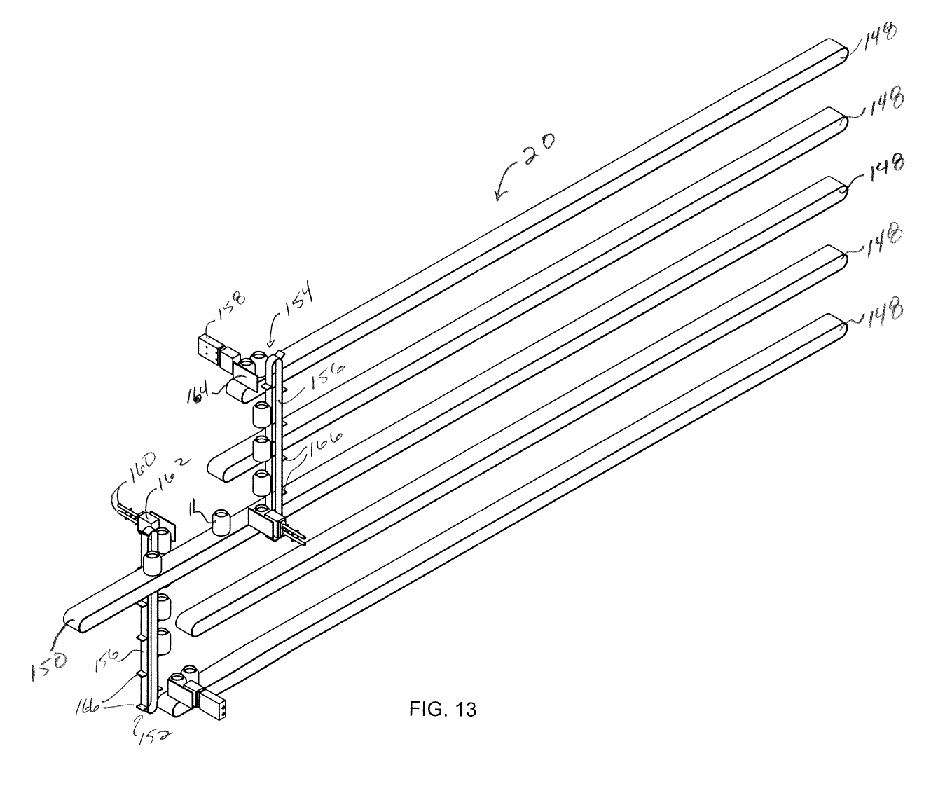

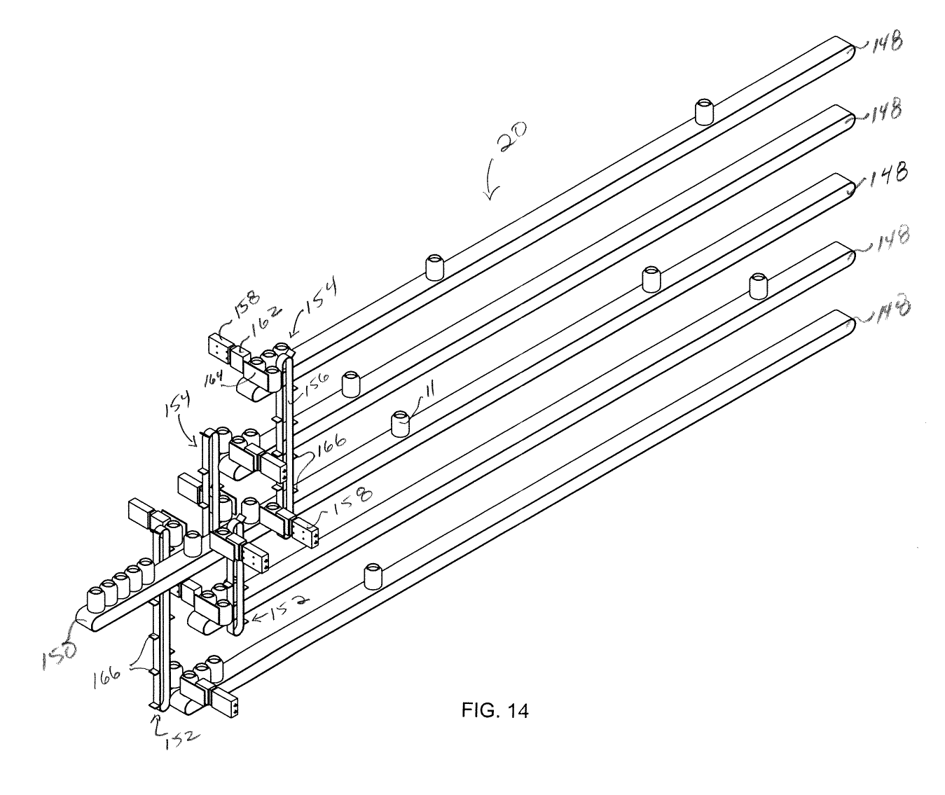

A conveyor assembly 20 is shown in FIGS. 13 and 14 to include a tiered arrangement of endless belt-type conveyors 148 driven by a series of rollers that are operably connected to one or more conveyor actuators. In the illustrated embodiment, five conveyors are depicted, with the center conveyor functioning as an exit or discharge conveyor 150. Alternatively, the discharge conveyor 150 could be positioned at the top or bottom or at any level of the conveyor tier assembly 20. It is also foreseen that any other suitable lateral transport mechanisms could be substituted for the conveyor belts. A plurality of elevator and lowerator assemblies 152 and 154 are provided to enable transfer of the containers 11 upwardly and downwardly from the various tiers onto the discharge conveyor. The elevator and lowerator assemblies 152 and 154 are of similar construction, each including a vertically mounted endless conveyor-type belt 156 and an actuator 158 for actuating a pair of piston rods 160 that drive an ejector 162. A stop 164 is connected to the ejector 162 to extend in the direction of the conveyor 148. Each vertical belt 156 includes a series of spaced platforms or steps 166 that extend outboard from the belt, travel with the belt 156 as it rotates, and are sized for reception of the containers 11. When a container advances on a respective conveyor 148 to an elevator or lowerator assembly 152 or 154, the actuator 158 advances the ejector 162 and the attached stop 164 to extend across the conveyor to halt travel of the container and direct it onto a step 166. The rotating belt 156 then carries the container upwardly or downwardly to the discharge conveyer 150. FIG. 14 depicts a pair of lowerators 154 transferring containers 11 from two upper conveyors 148 to a centrally positioned discharge conveyor 150, while a pair of elevators 152 transfers containers from two lower conveyors 148 to the discharge conveyor 150.

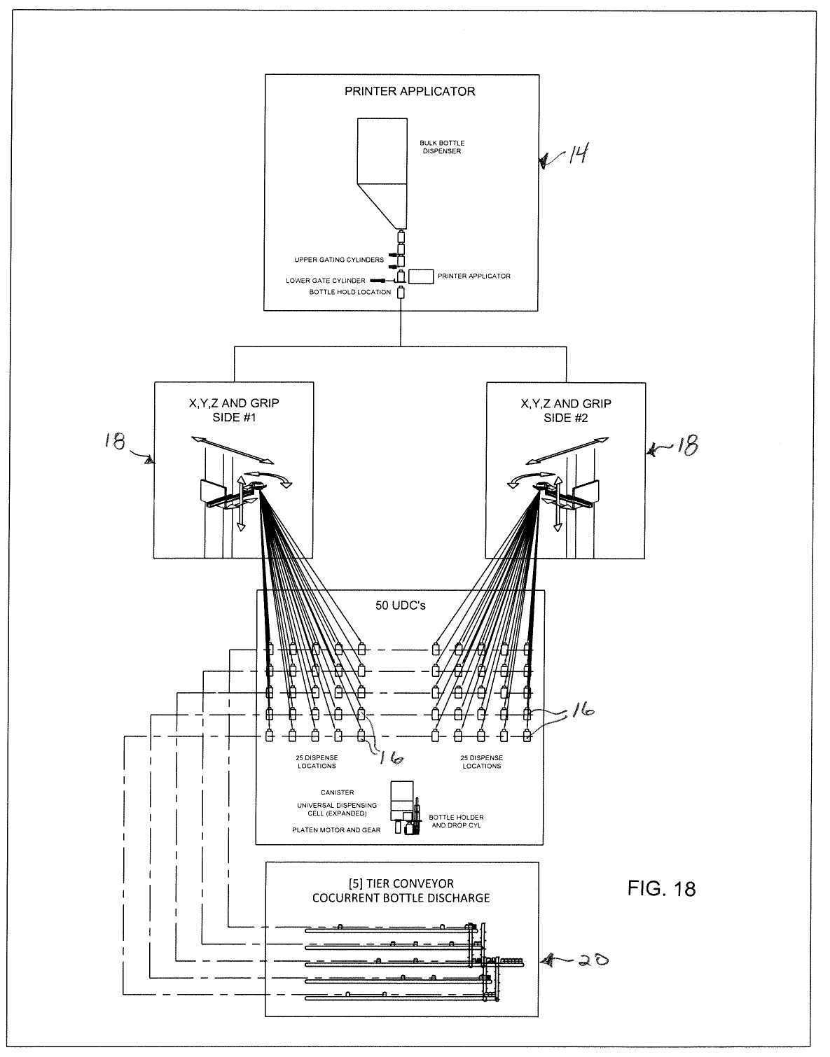

FIG. 18 is a diagrammatic representation of one embodiment of the operation of the automatic dispensing system 10 having a pair of pick ad place assemblies 18 and 50 dispensing modules 16. The container dispense and print assembly 14 is centrally located between the dispensing modules 16 for discharging and labeling containers 11 in singulate fashion for quick pick up by a pair of pick and place assemblies 18. These assemblies 18 transport the labeled containers to various product dispensing modules 16, where they are filled and ejected onto an adjacent conveyor 148 of the conveyor tier assembly 20.

Operation of the various components of the automatic dispensing assembly is coordinated by the control system 22 to achieve optimum speed, efficiency and accuracy. As shown in FIG. 1A, the control system 22 includes a control unit 168 in communication with a computer 170 having a user interface 172. The control unit 168 is in electrical communication with the dispensing system 10 via wired and/or wireless communication. The user interface 172 may be a hand-held device in wired and/or wireless communication with the control unit 168 of the dispensing system. The user interface 172 provides means for a user to control operation of the dispensing system 10, for example, entering parameters or commands for processing by the control unit 168. The control unit 168 uses a programmable logic controller or other control system to process communications and control operations of components of the dispensing system 10.

In one embodiment, a computer 170 or other personal computing device may be used in place of or in conjunction with the user interface 172 to communicate with the control unit 168. The computer 170 (as well as user interface and control unit 172) may include one or more processors for executing one or more computer-readable programs. To facilitate operation, the components may also include a memory controller for interfacing a main memory with the one or more processors for retrieving information, such as instructions of a program, and/or storing information used by the system. The control system 22 may also include an input/output (I/O) interface to interface I/O devices with the processors. I/O devices may also include an input device (not shown), such as an alphanumeric input device, including alphanumeric and other keys for communicating information and/or command selections to the processors. Another type of user input device includes cursor control, such as a mouse, a trackball, or cursor direction keys for communicating direction information and command selections to the processors and for controlling cursor movement on the display device.

The computer 170 may include a dynamic storage device, referred to as main memory, or a random access memory (RAM) or other computer-readable devices for storing information and instructions to be executed by the processors. Main memory also may be used for storing temporary variables or other intermediate information during execution of instructions by the processors. In addition, the computer 170 may be connected to a network through one or more network communication ports to provide information to or receive information from the network. In one embodiment, the network is the Internet and the network communication port includes an Internet modem. The computer may also receive information, such as information concerning a product associated with the dispensing system 10, which may be used by the system during dispensing of one or more products. Alternatively, or in conjunction with the network, the computer may be in communication with one or more databases to store information concerning the dispensing system 10.

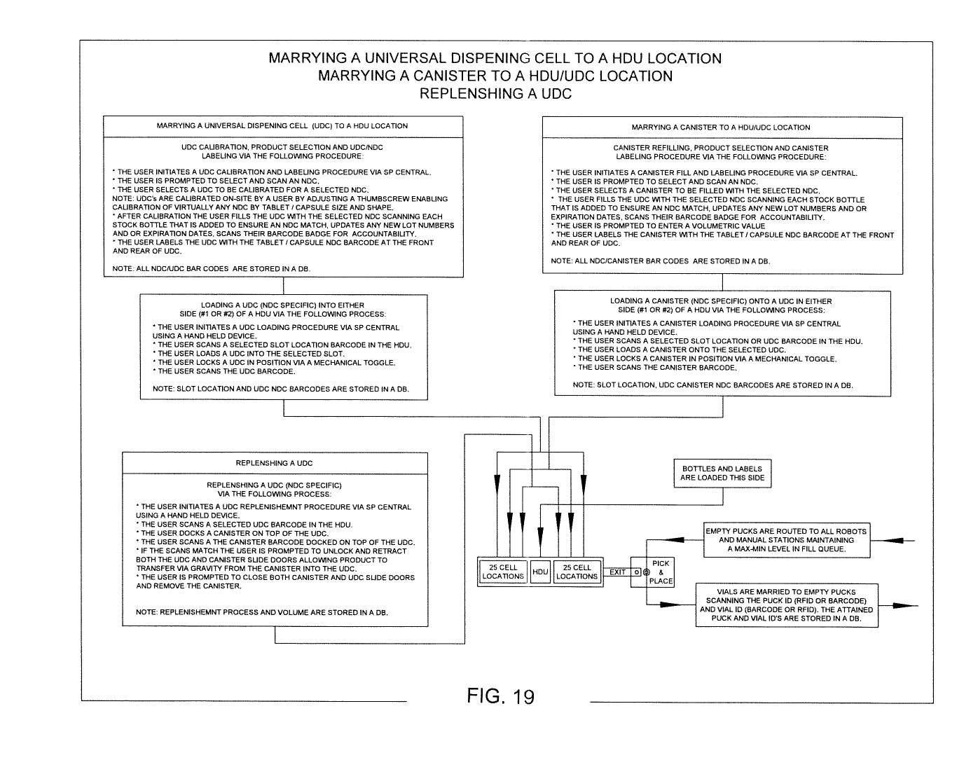

FIG. 19 shows the process of identifying or “marrying” a dispensing cell 84 and product storage canister 82 to the coordinates of a particular location assigned to a dispensing module 16 and replenishing the canister 82 as needed. One method of filling product storage canisters from manufacturers' pill containers, logging the contents into the control system 22 and installing the canisters onto selected dispensers and readied to fill prescription drug containers is described in U.S. patent application Ser. Nos. 12/396,417 and 13/058,795 for AUTOMATED PRECISION SMALL OBJECT COUNTING AND DISPENSING SYSTEM AND METHOD, the entire contents of which applications is incorporated herein by reference.

In a method of use of the dispensing system 10 in association with pharmaceutical products, an operator assigns each inventory product to a respective product dispensing module 16. The dispensing cell 84 is charged by an operator depositing a specified quantity of the product into the canister 82. The operator scans the barcode ID of location coordinates or enters into the user interface 172 the location coordinates of the dispensing module within the rack 12 as well as the quantity of product that has been loaded. The control unit 168 associates the dispensing module 16 with a position on the rack 12. A user may employ the user interface 172 to enter order information, for example, a plurality of prescriptions.

The control unit 168 then commands the container gating system 44 to release containers 11 one at a time from the hopper discharge chute 42 onto the sliding gate 50 and instructs the printer applicator unit 78 to print and apply to the container a patient specific identifying label in accordance with a selected prescription. The control unit commands the actuator 54 to deploy the piston rods 56 to shift sliding gate 50 from a container well covering position to an exposed aperture position. This allows a labeled container 11 to drop through the open aperture 58 and into the well 60. As labeled containers drop one at a time into the well 60, the control unit commands a robotic transfer unit 130 or 132 to travel to the well 60. The first in—first out printer applicator subassembly 38 enables the control unit 168 to upload label information to a database. The optical scanner 142 on the pick and place arm 138 or 140 reads and transmits label information to the control unit where the information is processed. The control unit 168 may use the computer 170 to retrieve information from the database or network to determine the location of a product dispensing module 16 having products that correspond to information printed on the label.

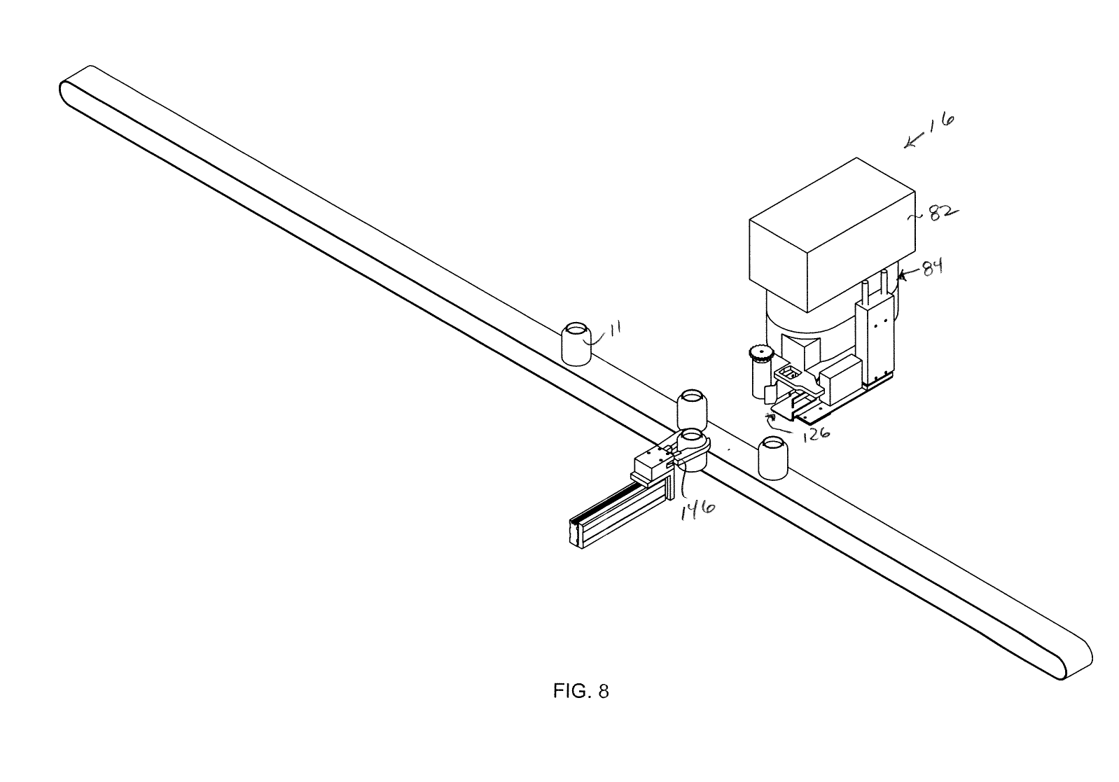

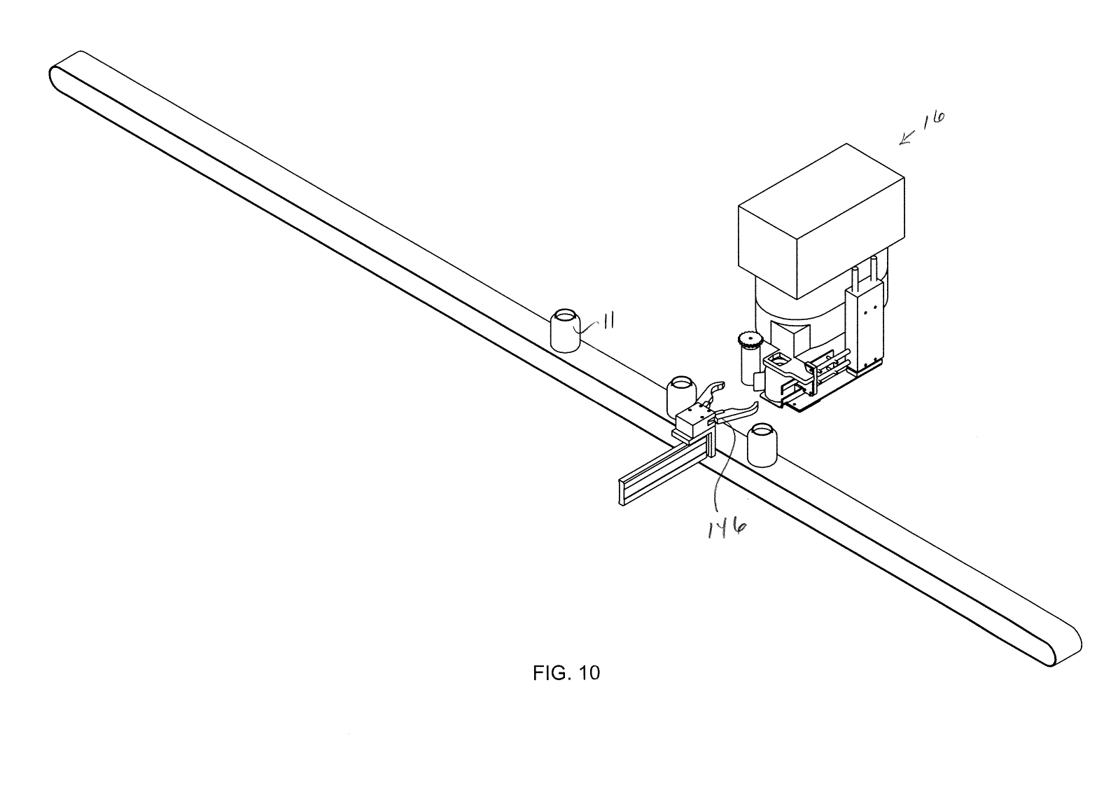

The arm 138 or 140 grasps the labeled container and, under direction of the control unit, a respective robotic transfer unit 130 or 132 transports the labeled container to an available product dispensing module 16 containing the correct product. The container induction module 86 in an available product dispensing module 16 is in the raised position shown in FIGS. 8-10, with the guided lift piston rod 108 retracted and the container port 104 positioned adjacent the outlet 94 and below the counting sensor 96. The arm 138 or 140 places the container 11 on the bottom plate 120 of the container port 104 of the selected dispensing module 16. The control unit 168 confirms the location of the dispensing module 16 by scanning the identifying barcode. The control unit 168 next commands the dispensing module 16 to dispense the selected small objects one at a time from the dispensing cell 84. As they are dispensed, the small objects pass adjacent the counting sensor 96, which transmits counting data to the control module. The control module transmits this information to the computer 170 so that the record of the product inventory stored at the canister 82 and dispensing cell 84 can be appropriately debited. This ensures that the canister 82 will be replenished when a predetermined inventory level is reached. The counted objects continue to drop one at a time into the container 11 until the number requested by the control unit has been dispensed.

When the labeled container 11 has been filled, the control unit 168 actuates the guided piston rod 108 of the container lift unit 100 to lower the base 98 until it is positioned adjacent the conveyor tier 148 serving the product dispensing module 16. The control unit 168 actuates the guided piston rod 112 of the ejector assembly 102 to urge the ejector plate 114 forwardly. The generally U-shaped configuration of the plate 114 enables the fixed side supports 124 to pass through the window area 118 as the ejector plate advances. The ejector plate 114 urges the filled container 11 forwardly until it passes out through the opening 126 of the ejector assembly 102 and onto the adjacent conveyor 148.

While the dispensing module 16 is filling and ejecting a labeled container, the robotic transfer unit 132 or 134 transfers the arm 138 or 140 back to the container well 60 of the container dispense and print assembly 14. The arm 138 or 140 picks another labeled container and delivers it to a selected dispensing module 16, which may be the same dispensing module, or a different module. The pick and place arms 138 and 140 may concurrently pick up newly labeled containers and deliver them to selected dispensing modules 16, while other multiple product modules 16 may concurrently fill and eject their filled containers 11 onto their respective adjacent conveyor tiers 148.

The containers 11 travel along the conveyor units until they reach the an elevator or lowerator unit 152 or 154, where they are routed by the cooperative action of the ejector 162 and stop 164 onto a step 166 that carries the container upwardly or downwardly to the discharge conveyor 150. Because the filled containers 11 are already labeled and filled with products described on their respective labels, they may be deposited on the discharge conveyor 150 in any convenient order. The order in which the filled containers are placed on the discharge conveyor 150 is unrelated to the fill order. The discharge conveyor carries the filled containers 11 to one or more subsequent stations where the contents of each container is verified, and a cap or other similar closure is applied.

In this manner, the automated dispensing system 10 can efficiently dispense and imprint a stored container with unique printed information on one level, while a pick and place arm 138 or 140 grabs a recently labeled container from a container well 60 below and transports it to a selected corresponding product dispensing module 16, which may be located anywhere on the rack 12. While the pick and place arm 138 or 140 returns for another labeled container 11, another recently labeled container drops down into the well 60 of the dispense and print assembly 14, and another stored container drops down from the hopper 36 and is imprinted with different unique printed information.

At the same time, the dispensing module 16 dispenses the pre-selected product into a labeled container, lowers the filled container and ejects it onto an adjacent conveyor 148. Operation of the various components of the pick and place assembly 18 is coordinated to continue as containers filled by other dispensing modules 16 pass by on the conveyors 148. Also at the same time, the elevators and lowerators 152 and 154 of the conveyor assembly 20 operate to transfer filled, labeled containers from the conveyors 148 onto the discharge conveyor 150.

In one embodiment, the labeled containers are picked from the discharge conveyor 150, either manually or by a robotic pick and place arm such as arms 138 and 140 previously described. Each container is then placed in a container carrier or puck, which may be routed to one or more additional downstream handling stations for capping, verification and the like. One such carrier system is described in U.S. patent application Ser. No. 13/763,339 filed Feb. 8, 2013 for Container Carrier, which is incorporated herein by reference.

Because the containers are labeled before they are filled, they can be dropped off at the product dispensing module 16 and the pick and place assembly need not stay in position at the dispenser module while the transferred container is filled. The robotic transfer units 130 and 132 are able to return immediately after drop off to the container dispense and print assembly 14. Thus, the time required for transferring a new container to the dispensing module and return to pick up another container is substantially shortened. Similarly, because the products are supplied to a pre-labeled container, the product dispensing modules 16 are able to simultaneously eject filled containers onto an adjacent conveyor 148 of the conveyor assembly 20, where they can routed to a discharge conveyor 150 for exit directly to verification and capping without the need to keep them in order for subsequent labeling. The products are ejected onto a multi-tier conveyor assembly, enabling the product dispensing modules 16 to concurrently discharge a plurality of filled containers. The elevator and lowerator structures 152 and 154 enable the filled containers to converge on a single discharge conveyor.

It is to be understood that while certain forms of the automatic dispensing system and method have been illustrated and described herein, the invention is not to be limited to the specific forms or arrangement of parts described and shown. Having thus described preferred embodiments of the present disclosure, the following is claimed as new and desired to be secured by Letters Patent:

I claim:

1. An automated system for storing and dispensing small objects, comprising:
a. a container dispensing module for storing and discharging a plurality of labeled containers;
b. the container dispensing module including a printer applicator disposed to print selected information on a label and apply the label to a container as it is discharged from the container dispensing module;
c. a plurality of automated product dispensing cells for dispensing selected numbers of small objects into labeled containers;
d. a container transport unit configured to pick a container from the container dispensing module after it is labeled and transport it to a selected product dispensing cell to be filled with a selected number of small objects;
e. a conveyor assembly disposed to transport filled containers away from the product dispensing cells; and
f. a control unit controlling printing of the labels, transport of the labeled containers to a dispensing module containing small objects specified on the label, and dispensing into the labeled containers the quantity of small objects specified on the labels.

2. The automated system of claim 1, further including:
a. a container transport unit configured to pick a labeled container from the container dispensing module and transport the container to a selected one of the plurality of product dispensing cells, and travel back to the container dispensing module while the selected product dispensing cell fills the labeled container.

3. The automated system of claim 1, the container dispensing module further including:
a. a hopper for storing a plurality of containers;
b. the hopper including a chute; and
c. a gate connected with the chute and operable from a closed position in which a line of containers is retained within the chute, and an open position, in which a container is released from the chute.

4. The automated system of claim 3, wherein the printer applicator is disposed below the hopper chute.

5. The automated system of claim 1, further including:
a. a plurality of container induction modules, each connected to a product dispensing cell and configured to lower filled containers from the product dispensing cell and shift them onto the conveyor for transporting the filled containers away.

6. The automated system of claim 1, wherein the conveyor transports the filled containers to a verification station.

7. An automated system for storing and dispensing small objects, comprising:
a. a container dispensing module including
a hopper for storing a plurality of containers,
the hopper having a chute configured to dispense only one container at a time, and
a label unit disposed for printing and labeling a container as it is discharged from the container dispensing module;
b. a plurality of product dispensing modules, each product dispensing module including
a storage canister for storing small objects,
a product dispensing cell for dispensing and counting a plurality of the stored small objects, and
a container induction module configured to receive and eject filled containers;
c. a track disposed adjacent said container dispensing module and product dispensing modules;
d. a container transport assembly including a container transfer unit configured for sliding travel back and forth along the track;
e. a conveyor assembly disposed to receive filled containers as they are ejected from the container induction module;
f. a control unit controlling printing of the labels, transport of the labeled containers to a dispensing module containing small objects specified on the label, and dispensing into the labeled containers the quantity of small objects specified on the labels; and
g. the container transfer unit configured to pick a container discharged from the container dispensing module, transport the container to a product dispensing module, and travel back to the container dispensing module while the product dispensing module fills and ejects a filled container onto the adjacent conveyor.

8. The automated system of claim 7, wherein:
a. the container transport assembly includes a sliding rail for travel back and forth along the track;
b. the container transfer unit includes a container manipulator arm having a grip unit and an optical scanner;
c. the manipulator arm is mounted for sliding travel up and down along the rail; and
d. the optical scanner is disposed to read identifying codes on the dispensing cells and transmit them to the control unit.

9. The automated system of claim 7, wherein the conveyor assembly further includes:
a. a plurality of conveyors disposed in a tier;
b. one of the plurality of conveyors comprises a discharge conveyor; and
c. each other of the plurality of conveyors is connected to an elevator or lowerator assembly configured to carry containers on the other conveyors upwardly or downwardly to the discharge conveyor.

10. An automated system for storing and dispensing small objects, comprising:
a. a hopper for storing a plurality of containers, the hopper having a discharge chute for dispensing a line of upright containers;
b. the chute including a pair of gates having a closed position for retaining a line of containers within the chute, and an open position wherein a single container is released from the chute;
c. a label unit disposed below the chute and including a platform for receiving a container as it is released from the chute;
d. the platform including a shiftable gate covering an opening;
e. a container well that is disposed below the opening and has a lower support, a front opening, and sidewalls configured to receive and retain a container within the well;
f. a plurality of dispensing cells for storing and dispensing a selected number of small objects into a container;
g. each dispensing cell including a storage canister having an outlet and a drive unit for dispensing a plurality of small objects through the outlet;
h. each dispensing cell including a filling port for receiving a container;
i. a manipulator arm for grasping a labeled container and removing it from the container well and delivering the labeled container to a filling port of one of the dispensing cells;
j. each filling port including a base, a front opening, a pair of sidewalls and a rear wall, one of the sidewalls being configured to bias the container against the other sidewall and the rear wall,
k. each filling port including an ejector actuable to shift the rear wall forwardly past the opening for ejecting the container from the filling port;
l. control means controlling movement of the gripping arm and dispensing of small objects by the dispensing cells; and
m. conveyor means for transporting filled containers from the dispensing cells to a verification station.

11. The automated system of claim 10, wherein each dispensing cell further includes:
a. a lift unit connecting the base with the filling port; and
b. the lift unit being actuable to raise and lower the filling port with respect to the dispensing cell.

12. The automated system of claim 10, wherein the conveyor means includes a plurality of conveyors for simultaneous transport of filled containers away from a plurality of product dispensing cells to a verification station.
